(19) United States
(12) Patent Application Publication
(10) Pub. No.: US 2002/0138704 A1
(43) Pub. Date: Sep. 26, 2002

(54) METHOD AND APPARATUS FAULT TOLERANT SHARED MEMORY

(76) Inventors: STEPHEN W. HISER, ROUND ROCK, TX (US); STEPHEN H. MILLER, ROUND ROCK, TX (US); JAMES R. ALEXANDER, AUSTIN, TX (US); THOMAS J. DAVIDSON, AUSTIN, TX (US); DOUGLAS E. JEWETT, ROUND ROCK, TX (US); GLEN W. GORDON, AUSTIN, TX (US); DAVID P. SONNIER, AUSTIN, TX (US)

Correspondence Address: FENWICK & WEST LLP, TWO PALO ALTO SQUARE, PALO ALTO, CA, 94306, US

(21) Appl. No.: 09/213,300

(22) Filed: Dec. 15, 1998

(51) Int. Cl. G06F 12/16

(52) U.S. Cl. 711/162; 711/148; 714/6

(57) ABSTRACT

A method and apparatus for providing paired or shadowed shared memory within UNIX and UNIX-like environments is provided. For the present invention shared memory segments, established using System V-like shared memory commands, are registered or paired. Once paired checkpointing operations may be performed by pushing or pulling data between paired segments. These checkpointing operations may be synchronous or asynchronous. The present invention also allows client processes to determine the status of shared memory segments and the status of checkpointing requests.

### FIELD OF THE INVENTION

The present invention relates generally to shared memory within fault tolerant computer systems. More specifically, the present invention includes a method and apparatus for providing fault tolerant shared memory within UNIX and UNIX-like environments.

### BACKGROUND OF THE INVENTION

UNIX and UNIX-like environments typically provide a range of different techniques for interprocess communication or IPC. Functionally, the use of IPC provides a programming model where the utility of large monolithic processes can be split into one or more smaller processes. These smaller processes can be arranged using peer-to-peer or client/server relationships. Splitting in this fashion offers a number of advantages including ease of implementation, component reusability, and encapsulation of information. These advantages have made IPC techniques popular and widely used programming tools.

Shared memory is a widely used IPC technique. Shared memory allows a group of processes to share a common memory segment. Changes made to the shared segment are immediately visible to each of the processes that use the segment. This allows processes to rapidly exchange data without the need for physical input/output common to other IPC techniques.

Most UNIX and UNIX-like systems use a form of shared memory originally developed for AT&T's System V UNIX. To establish a shared memory segment using System V shared memory, a process calls:

int shmget (key_t key, int size, int flag);

Shmget( ) returns an identifier that the operating system associates with the new memory segment. Key is a value that processes may use in later calls to shmget( ) to obtain the same identifier. Flag is a logical value that includes the predefined value IPC_CREAT and may include the predefine value IPC_EXCL. If specified, IPC_EXCL indicates that an error should be returned if a segment has previously been created for the specified key. Size specifies the number of bytes that will be included in the new memory segment.

In response to the shmget( ) call, the operating system creates a new structure of the form:

struct shmid_ds {

| | |
|---|---|
| struct ipc_perm shm_perm; | /* segment access permissions */ |
| struct anon_map *shm_map; | /* pointer to memory map */ |
| int shm_segsz; | /* size of segment in bytes */ |
| ushort shm_lkcnt; | /* number of locks on segment */ |
| pid_t shm_lpid; | /* pid of last shmop() */ |
| pid_t shm_cpid; | /* pid of creator */ |
| ulong shm_nattch; | /* number of current attaches */ |
| ulong shm_cnattch; | /* used for shminfo */ |
| time_t shm_atime; | /* last attach time */ |
| time_t shm_dtime; | /* last detach time */ |
| time_t shm_ctime; | /* last change time */ |

};

The created shmid_ds structure describes the new memory segment.

Each process (except for the establishing process) that wishes to use an established shared memory segment must obtain the shared memory segment. Processes obtain a shared memory segment by calling shmget( ) using the same key used to establish the shared memory segment. In these subsequent calls, size and flag are ignored. Shmget( ) returns the identifier originally returned to the process that established the shared memory segment.

After establish or obtaining a shared memory segment, each process must attach the segment at an address within the processes' virtual memory space. This is done by calling:

void *shmat (int shmid, void *addr, int flag);

Shmid is the identifier that the calling process received from shmget( ). Shmaddr suggests an address for attachment. If Shmaddr is zero, any address may be used for the point of attachment. Shmflag is a logical value that may include any combination of the predefined values IPC_RND and IPC_RDONLY. If IPC_RND is specified, the address used for attachment may be rounded down to properly align the segment being attached. If IPC_RDONLY is specified, the segment is attached read-only.

After calling shmat( ), a process may access the attached shared memory segment at the address returned in addr.

Processes detach from a shared memory segment using the call:

int shmdt (void *addr);

Addr is the value returned by a previous invocation of shmat( ). Detaching does not delete a shared memory segment unless the segment has been marked for deletion and all processes have detached. To mark a shared memory segment for deletion, processes call:

int shmctl (int shmid, int cmd, struct shmid_ds *buf);

Shmid is the identifier that the calling process received from shmget( ). Shmflag is a logical value that includes the predefined value IPC_RMID. Buf is ignored when used in combination with IPC_RMID. Once marked for deletion, a shared memory segment will be removed after all processes have detached from the segment.

As described above, System V shared memory provides a relatively effective and straightforward set of routine for establishing shared memory segments (shmget( )), obtaining existing shared memory segments (shmget( )), attaching shared memory segments (shmat( )), detaching shared memory segments (shmdt) and marking shared memory segments for deletion (shmctl( )). This has made System V shared memory a widely used programming tool.

Unfortunately, shared memory systems, including System V shared memory, are generally not configured to provide fault-tolerant operation. As a result, data stored in shared memory segments is generally lost in the event of a system failure. The lack of fault tolerance is especially serious because shared memory encourages applications to work cooperatively. As a result, a great deal of data may be lost during system failure and a great number of processes may be negatively impacted. As a result, there is a need for shared memory systems that provide fault-tolerant operation. This is especially true for the widely used System V shared memory system.

### SUMMARY OF THE INVENTION

An embodiment of the present invention includes a system for providing fault tolerant shared memory within UNIX and UNIX-like environments. More specifically, the present invention includes three system calls that work in combination with the existing System V shared memory interface. The new system calls are:

int shm_sdwctl (int shmid, int cmd, int rem_key, int rem_nodeid, uint ssm_flag);

int shm_sdwchkpt (int shmid, caddr_t sdw_addr, int size, uint ssm_flag);

int shm_sdwstat (int shmid, int cmd, int ckkpt_id, caddr_t sdw_addr);

The new calls allow processes, executing on different nodes within a computer network, to create and use shared memory in a paired or shadowed mode. For shadow mode operation, a first node is designated as a primary node and a second node is designated as a secondary node. A primary process executing on the primary node creates a primary shared memory segment using a primary key and the shmget( ) routine. A secondary process executing on the secondary node creates a secondary shared memory segment using a secondary key and the shmget( ) routine. The primary and secondary processes then attach their respective shared memory segments using calls to shmat( ). Other processes, executing on the primary or secondary nodes, may also attach either of the shared memory segments.

The primary and secondary processes then make respective calls to shm_sdwctl( ) to register the primary and secondary shared memory segments. During the registration process, the operating system on the primary and nodes update their in-memory data structures that describe the primary and secondary memory segments. In particular, the data structure that describe each memory segment are updated to include the key associated with the other memory segment (i.e., the data structures describing the primary memory segment are updated to include the key associated with the secondary memory segment and the data structures describing the secondary memory segment are updated to include the key associated with the primary memory segment).

After registration, processes operating on the primary node or the secondary node may call the shm_sdwchkpt( ) routine to checkpoint data from the primary memory segment to the secondary memory segment. In cases where a process executing on the primary node calls shm_sdwchkpt( ), data is pushed from the primary node to the secondary node. In the case where a process executing on the secondary node calls shm_sdwchkpt( ), data is pulled from the primary node to the secondary node. Calls to shm_sdwchkpt( ) may specify that that data be transferred synchronously, or asynchronously.

Processes use the shm_sdwstat( ) routine to retrieve the status of the primary and secondary memory segments, the status of an ongoing asynchronous shm_sdwchkpt( ) request or the status of a failed shm_sdwchkpt( ) request.

As described, the shm_sdwctl( ), shm_sdwchkpt( ), int shm_sdwstat( ) provide a convenient and effective method for configuring shared memory segments to function in a shadowed mode. Use of shadowing means that critical data maintained in shared memory may be periodically checkpointed. This allows the secondary process to use the secondary memory segment to recover from the loss of the primary node. Thus, the present invention provides shared memory that operates in a fault-tolerant fashion.

Advantages of the invention will be set forth, in part, in the description that follows and, in part, will be understood by those skilled in the art from the description herein. The advantages of the invention will be realized and attained by means of the elements and combinations particularly pointed out in the appended claims and equivalents.

### BRIEF DESCRIPTION OF THE DRAWINGS

The accompanying drawings, that are incorporated in and constitute a part of this specification, illustrate several embodiments of the invention and, together with the description, serve to explain the principles of the invention.

FIG. 1 is a block diagram of a computer network or cluster shown as an exemplary environment for an embodiment of the present invention.

FIG. 2 is a block diagram of an exemplary computer system as used in the computer network of FIG. 1.

FIG. 3 is a block diagram showing the entities deployed within the memories of a primary computer node and a secondary computer node during a representative use of an embodiment of the present invention.

### DETAILED DESCRIPTION OF THE PREFERRED EMBODIMENTS

Reference will now be made in detail to preferred embodiments of the invention, examples of which are illustrated in the accompanying drawings. Wherever convenient, the same reference numbers will be used throughout the drawings to refer to the same or like parts.

Environment

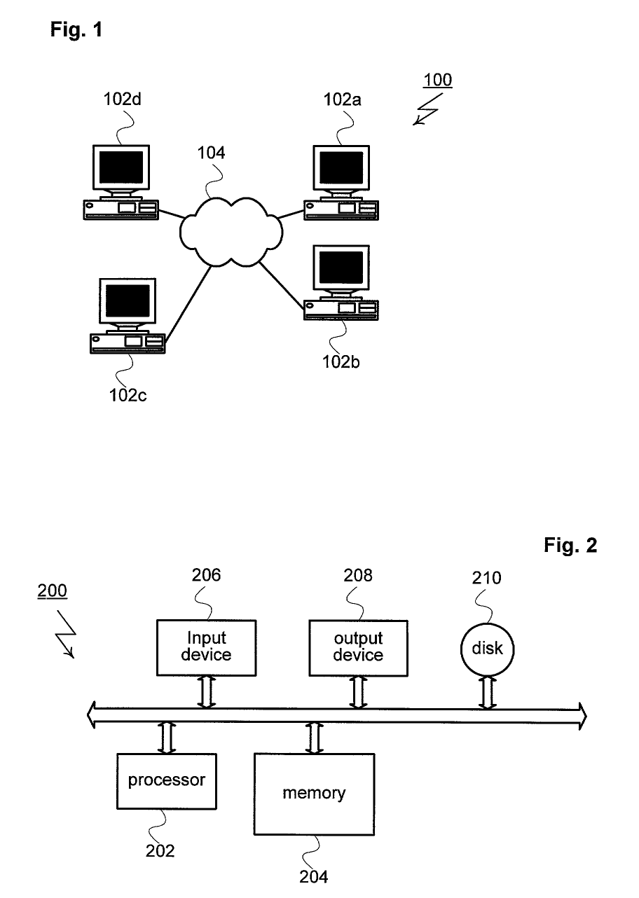

In FIG. 1, a computer cluster is shown as a representative environment for the present invention and generally designated 100. Structurally, computer cluster 100 includes a series of nodes, of which nodes 102a through 102d are representative. Nodes 102 are intended to be representative of a wide range of computer system types including personal computers, workstations and mainframes. Although four nodes 102 are shown, computer cluster 100 may include any positive number of nodes 102. Nodes 102 are interconnected via computer network 104. Network 104 is intended to be representative of any number of different types of networks.

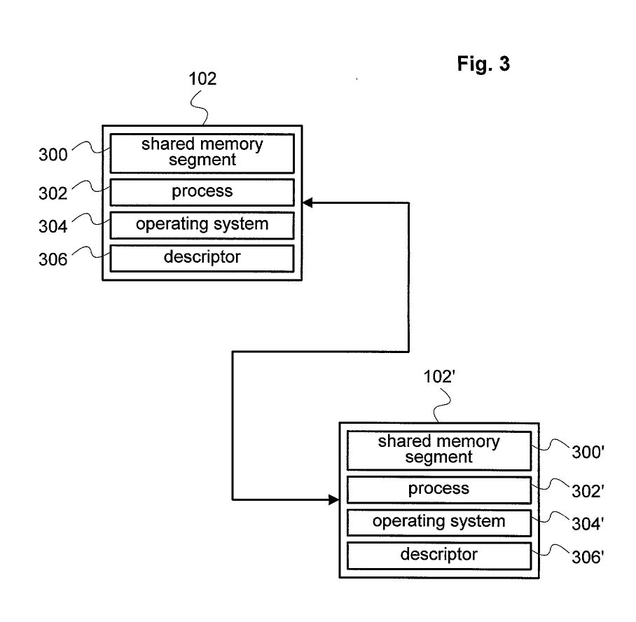

As shown in FIG. 2, each node 102 includes a processor, or processors 202, and a memory 204. An input device 206 and an output device 208 are connected to processor 202 and memory 204. Input device 206 and output device 208 represent a wide range of varying I/O devices such as disk drives, keyboards, modems, network adapters, printers and displays. Each node 102 also includes a disk drive 210 of any suitable disk drive type (equivalently, disk drive 210 may be any non-volatile storage system such as “flash” memory).

To more clearly describe the present invention, FIG. 3 shows two nodes 102 from network 100. These nodes are referred to as primary node 102 and secondary node 102′. Primary node 102 and secondary node 102′ each include respective shared memory segments 300, processes 302, operating systems 304, and descriptors 306. Operating systems 304 may be selected from any suitable type. For the specific example of FIG. 3, it may be assumed that operating systems 304 are UNIX or UNIX-like.

Shared memory segments 300 are intended to be representative of System V, or System V-like shared memory segments. Processes create segments of this type using the shmget( ) system call. Shmget( ) requires the calling process to supply a unique key value for each segment to be created. In this description, the unique key value used to generate shared memory segment 300 is referred to as the primary key value. The unique key value used to generate shared memory segment 300′ is referred to as the secondary key value. The primary and secondary key values are defined in a way that allows the value of each key to be known within each node 102. This means that the value of the primary key may be accessed by secondary node 102′ and the value of the secondary key may be accessed by primary node 102.

Shmget( ) returns an integer value, known as a descriptor, for each shared memory segment that shmget( ) creates. Descriptors 306 are the values that shmget( ) returned after creating shared memory segments 300.

Processes 302 are intended to be representative clients of their co-located shared memory segments 300. To become clients, each process 302 must obtain the descriptor 306 associated with its co-located shared memory segment 300. Processes 302 obtain the appropriate descriptor 306 by calling shmget( ) (either as part of segment creation or subsequently). After obtaining the appropriate descriptor 306, processes 302 attach their co-located shared memory segment 300 by calling shmat( ). In general, it should be noted that shared memory segments 300 may, or may not, have been created by processes 302.

Shadowed Shared Memory API

An embodiment of the present invention includes an API for creating and using shadowed shared memory segments. The API preferably includes the following systems calls:

int shm sdwctl (int shmid, int cmd, int rem_key, int rem_nodeid, uint ssm_flag);

int shm_sdwchkpt (int shmid, caddr_t sdw_addr, int size, uint ssm_flag);

int shm_sdwstat (int shmid, int cmd, int ckkpt_id, caddr_t sdw_addr);

The systems calls in this API allow processes 302 to use shared memory in a paired or shadowed mode. The first of these system calls, shm_sdwctl( ) allows processes 302 to control shadow mode operation. Using shm_sdwctl( ) processes 302 (and any other processes that are clients of shared memory segments 300) register, unregister, suspend or unsuspend shared memory segments 300. Shared memory segments 300 are registered to pair them for shadow mode operation. Unregistering splits previously paired shared memory segments 300. Suspending previously paired shared memory segments 300 temporarily prevents shadow mode operation. Unsuspending restores shadow mode operation to previously suspended paired shared memory segments 300.

The second system call, shm_sdwchkpt( ) allows processes 302 to checkpoint data between shared memory segments. Processes may use shm_sdwchkpt( ) to checkpoint data synchronously or asynchronously. Synchronous checkpointing means that the shm_sdwchkpt( ) call blocks until the completion of the checkpointing operation. asynchronous checkpointing means that the checkpointing operation is queued and the .shm_sdwchkpt( ) call returns immediately.

The third system call, shm_sdwstat( ) allows processes 302 to determine the status of a shared memory segment 300 or previously made asynchronous checkpointing request. Using shm_sdwstat( ), processes 302 may determine the overall status of a particular shared memory segment 300. Processes 302 may also use shm_sdwstat( ) to determine the status of an individual checkpointing request. Processes 302 may also use shm_sdwstat( ) to determine the status of the last checkpointing resulted in error.

Registration of Shared Memory Segments

To register a memory segment 300, a calling process 302 passes five arguments to shm_sdwctl( ). The first of these arguments is the descriptor 306 associated with the shared memory segment 300 being registered. The second argument is the predefined value SM_REG. This predefined value informs shm_sdwctl( ) that the calling process 302 is requesting registration of a shared memory segment 300. The third argument is the unique key value of the shared memory segment 300 that will be paired with the shared memory segment 300 being registered. Thus, when shm_sdwctl( ) is called to register shared memory segment 300, the third argument is the unique key value of shared memory segment 300′ (i.e., the secondary key value). When shm_sdwctl( ) is called to register shared memory segment 300′, the third argument is the unique key value of shared memory segment 300 (i.e., the primary key value). The fourth argument is a value that identifies the node 102 where the remote shared memory segment 300 is located. For the particular embodiment being described, this value is the node id of secondary computer system 102′. Different embodiments may use different method to identify the remote node 102.

The final argument to shm_sdwctl( ) is a flag value that is formed a logical combination that includes one of SSM_PRI and SSM_SEC and zero or more of the following: SSM_PUSH, SSM_PULL, and SSM_ENERR. SSM_PRI and SSM_SEC define whether the shared memory segment 300 will be registered as a primary or secondary memory segment (i.e., whether it will function in a primary or backup capacity). When set, SSM_PUSH indicates that checkpoint data may be sent, or pushed, to shared memory segment 302. SSM_PULL indicates that checkpoint data may be received, or pulled, from shared memory segment 302. SSM_ENERR controls operation in shared mode following a checkpointing error. When set, checkpointing operations are blocked (i.e., prevented) if a preceding checkpointing operation has failed. When SSM_ENERR is not set, a process can retry checkpointing if a preceding checkpointing operation fails.

Registration of Shared Memory Segments (Primary Node Operation)

For the example of FIG. 3, it is assumed that process 304 registers shared memory segment 300 as a primary segment (i.e., process 304 calls shm_sdwctl passing the value SSM_PRI). Operating system 304 responds to this shm_sdwctl( ) registration request by retrieving the internal data structure that describes shared memory segment 300. For UNIX or UNIX-like operating systems, this data structure is declared as follows:

struct shmid_ds {

| | |
|---|---|
| struct ipc_perm shm_perm; | /* segment access permissions */ |
| struct anon_map *shm_map; | /* pointer to memory map */ |
| int shm_segsz; | /* size of segment in bytes */ |
| ushort shm_lkcnt; | /* number of locks on segment */ |
| pid_t shm_lpid; | /* pid of last shmop() */ |
| pid_t shm_cpid; | /* pid of creator */ |
| ulong shm_nattch; | /* number of current attaches */ |
| ulong shm_cnattch; | /* used for shminfo */ |
| time_t shm_atime; | /* last attach time */ |
| time_t shm_dtime; | /* last detach time */ |
| time_t shm_ctime; | /* last change time */ |
| long shm_pad3; | /* reserved for time_t expansion */ |
| struct ssm_ds *shm_ssm; | /* pointer to shadow memory info */ |
| long shm_pad4[SHM_PAD0]; | /* reserve area */ |

};

Operating system 304 uses the retrieved shmid_ds structure to verify the validity of the requested registration. As part of verification, operating system 304 checks the retrieved shmid_ds structure to ensure that a shared memory region has been allocated. Operating system 304 also ensures that the permissions of the requesting process 302 are adequate to perform the requested registration. As an additional check, operating system 304 ensures that the first and third arguments to shm_sdwctl( ) do not refer to the same shared memory segment 300. This prevents a shared memory segment 300 from being paired with itself.

In cases where the registration request is valid, operating system 304 creates and initializes a new ssm_ds data structure. Operating system 304 stores a pointer to the ssm_ds structure in the shm_ssm field of the shmid_ds structure associated with the shared memory segment 300 being registered. The ssm_ds data structure is declared as follows:

struct ssm_ds {

| | |
|---|---|
| unit ssm_flags; | /* control flags */ |
| int ssm_rem_key; | /* unique remote key */ |
| ioaddr_t ssm_loc_ioaddr; | /* I/O address of local shared |
| | memory region */ |
| ioaddr_t ssm_rem_ioaddr; | /* I/O address of remote shared |
| | memory region */ |
| pdev_t *ssm_rem_pdev; | /* physical device structure of remote |
| | node */ |
| int ssm_chkpt_id; | /* current checkpoint id */ |
| int ssm_out_req; | /* current number of outstanding |
| | requests */ |
| int ssm_err_cnt; | /* current number of errors in request |
| | status queue */ |
| struct ssm_stat *ssm_stat | /* pointer to request status queue */ |

};

Operating system 304 initializes the ssm_flags element within the new ssm_ds structure to be equivalent to the flags passed to shm_sdwctl( ) (i.e., the final argument). Operating system 304 initializes the ssm_rem_key element within the new ssm_ds structure to be equivalent to the remote key passed to shm_sdwctl( ) (i.e., the third argument).

Operating system 304 initializes the ssm_stat element of the ssm_ds structure to point to an array of ssm_stat data structures. The ssm_stat data structures are declared as follows:

struct ssm_stat {

| | |
|---|---|
| unit ssms_chkpt_id; | /* unique checkpoint id */ |
| unit ssms_state; | /* request state (complete, pending, |
| | error) */ |
| unit ssms_err; | /* error completion status */ |
| time_t ssms_qtime; | /* time request was queued */ |
| time_t ssms_etime; | /* elapsed time of execution */ |

};

Operating system 304 will subsequently use the array of ssm_stat structures to store information describing asynchronous operations involving shared memory segment 300. Operating system 304 stores a pointer to the array of ssm_stat structures in the ssm_stat element of the ssm_ds structure.

After creating the array of ssm_stat structures, operating system 304 sends a verification request to operating system 304′. In response to the verification request, operating system 304′ determines if shared memory segment 300′ has been registered as a backup for shared memory segment 300 (i.e., if process 302′ has Called shm_sdwctl( ) to register shared memory segment 300′). If shared memory segment 300′ has been registered, operating system 304′ determines if the third argument passed to shm_sdwctl( ) (i.e., the secondary key) matches shared memory segment 300′. If the key value passed to shm_sdwctl( ) matches shared memory segment 300′ and shared memory segment 300′ has been registered, operating system 304′ returns an address that corresponds to shared memory segment 300′. On systems where the required network addressing is supported, the address returned by operating system 304′ is a network address for shared memory segment 300′.

Operating system 304′ sends a response message to operating system 304. The response message indicates whether or not operating system 304′ successfully processed the verification request. In cases where verification was successful, the response message also includes the address or shared memory segment 304′. Operating system 304 responds to the response message by updating the ssm_ds data structure. If the verification request succeeded, operating system 304 stores the returned address in the ssm_rem_ioaddr of the ssm_ds data structure. Operating system also updates ssm_flags element to remove the value SSM_REG_PEND (if previously set). Operating system 304 also stores the physical device address of the secondary node 102′ in the ssm rem_pdev of the ssm_ds data structure. Once again, it should be appreciated that the specific value stored in ssm_rem_pdev is implementation dependent. Different environments and different types of computer networks may require different values. Operating system 304 then frees any resources required during the call to shm_sdwctl( ) and returns a value indicating that registration was successful.

If the response message from operating system 304′ indicates that the verification request failed, operating system 304 stores the value SSM_REG_PEND in the ssm_flags element of the ssm_ds data structure. Operating system 304 then frees any resources required during the call to shm_sdwctl( ) and returns a value indicating that registration was not successful.

Registration of Shared Memory Segments (Secondary Node Operation)

For the example of FIG. 3, it is assumed that process 304′ registers shared memory segment 300′ as a secondary segment (i.e., process 304′ calls shm_sdwctl passing the value SSM_SEC). The initial steps taken by operating system 304′ to response to this shm_sdwctl( ) registration request are similar to the steps just described for operating system 304 and shared memory segment 300. In particular, operating system 304′ retrieves the shmid_ds structure associated with shared memory segment 304′. Operating system 304′ uses this structure to verify the validity of the requested registration. Thus, as in the case of operating system 304 and shared memory segment 300, operating system 304′ ensures that shared memory segment 300′ has been allocated and that the permissions of the calling process are adequate to perform the requested registration. Operating system 304′ also ensures that the calling process has not requested that shared memory segment 300′ be paired with itself.

For valid registrations, operating system 304′ creates and initializes a ssm_ds data structure of the type previously described. Operating system 304′ initializes the ssm_flags element within the new ssm_ds structure to be equivalent to the flags passed to shm_sdwctl( ) (i.e., the final argument). Operating system 304′ initializes the ssm_rem_key element within the new ssm_ds structure to be equivalent to the remote key passed to shm_sdwctl( ) (i.e., the third argument).

Operating system 304′ stores the address of shared memory segment 300′ in ssm_loc_ioadder element of the ssm_ds structure. On systems where the required network addressing is supported, the address returned stored by operating system 304′ is a network address for shared memory segment 300′. Operating system 304′ then frees any resources required during the call to shm_sdwctl( ) and returns a value indicating that registration was successful.

Unregistration of Shared Memory Segments

Once registered, shared memory segments 300 may be used in a shadowed or paired mode. A previously registered shared memory segment 300 may be unregistered using the shm_sdwctl( ) call. To unregister a memory segment 300, a process 302 that is a client of the shared memory segment 300 passes two arguments to shm_sdwctl( ). The first of these arguments is the descriptor 306 associated with the shared memory segment 300 being unregistered. The second argument is the predefined value SM_UNREG. This predefined value informs shm_sdwctl( ) that the calling process 302 is requesting unregistration of a shared memory segment 300.

The operating system 304 that is co-located with a shared memory segment 300 (i.e., operating system 304 for shared memory segment 300 and operating system 304′ for shared memory segment 300′) begins to process an unregistration request by retrieving the shmid_ds structure associated with the shared memory segment 304 being unregistered. The co-located operating system 304 uses the shmid_ds structure to determine that the shared memory segment 300 has been allocated and is registered. The co-located operating system 304 determines that the permissions of the calling process are adequate to perform the requested unregistration.

Unregistration of Shared Memory Segments (Primary Node Operation)

In cases where the shared memory segment 300 being unregistered is a primary segment (as in the case of shared memory segment 300 of FIG. 3), the co-located operating system 304 performs a sequence of steps that gracefully shutdown paired operation of the shared memory segment 300. The co-located operating system 304 initiates the shutdown sequence by adding the SSM_SUSP and SSM_REG_PEND flags to the ssm_flags of the shared memory segment 300 being unregistered. The SSM_SUSP flag prevents any additional checkpointing requests from being queued during the call to shm_sdwctl( ). The SSM_REG_PEND flag prevents future registration requests.

The co-located operating system 304 then checks to see if there are any outstanding checkpoint requests for the shared memory segment 300 being unregistered. If there are any outstanding checkpointing requests, operating system 304 blocks completion of the unregistration request while the outstanding checkpointing requests are allowed to complete. The operating system 304 then frees the storage space used by the array of ssm_stat structures that is associated with the shared memory segment being unregistered. The storage space for the ssm_ds structure is then freed. The operating system 304 then sets the ssm_ds element of the shmid_ds structure for the shared memory segment 300 to null and returns to the calling process 302.

Unregistration of Shared Memory Segments (Secondary Node Operation)

In cases where the shared memory segment 300 being unregistered is a secondary segment (as in the case of shared memory segment 300′ of FIG. 3), the co-located operating system 304 performs a sequence of steps that gracefully shutdown paired operation of the shared memory segment 300. The co-located operating system 304 initiates the shutdown sending a shutdown message to the remote operating system (i.e., to the operating system 304 that is co-located with the primary shared memory segment that is paired with the secondary shared memory segment 300 being unregistered). The shutdown message informs the remote operating system 304 that the secondary shared memory segment 300 is being unregistered.

The remote operating system 304 checks to see if the primary shared memory segment 300 is registered. If so, the remote operating system 304 sets the SSM_REG_PEND flag for the primary shared memory segment 300 (that is paired with the secondary shared memory segment 300 being unregistered). The SSM_REG_PEND flag prevents future registration requests of the primary memory segment 300. The remote operating system 304 then checks to see if there are any outstanding checkpoint requests for the shared memory segment 300 being unregistered. The remote operating system 304 waits for any requests of this type to complete.

The local operating system 304 then frees the storage space used by the ssm_ds structure that is associated with the shared memory segment being unregistered. The local operating system 304 then sets the ssm_ds element of the shmid_ds structure for the shared memory segment 300 to null and returns to the calling process 302.

Suspension of Shared Memory Segments

Once registered, shared memory segments 300 may be used in a shadowed or paired mode. A previously registered shared memory segment 300 may be suspended to temporarily prevent shadowed mode operation. To suspend a memory segment 300, a process 302 that is a client of the shared memory segment 300 passes two arguments to shm_sdwctl( ). The first of these arguments is the descriptor 306 associated with the shared memory segment 300 being suspended. The second argument is the predefined value SM_SUSP. This predefined value informs shm_sdwctl( ) that the calling process 302 is requesting suspension of a shared memory segment 300.

Unlike the previously described uses of shm_sdwctl( ), calls to request suspension may only be performed for a primary shared memory segment 300. The operating system 304 that is co-located with a primary shared memory segment 300 (i.e., operating system 304 for shared memory segment 300) begins to process a suspension request by retrieving the shmid_ds structure associated with the shared memory segment 304 being suspended. The co-located operating system 304 uses the shmid_ds structure to determine that the shared memory segment 300 has been allocated and is registered. The co-located operating system 304 also determines that the permissions of the calling process are adequate to perform the requested suspension and that the shared memory segment has not been previously suspended.

The co-located operating system 304 then adds the SSM_SUSP flag to the ssm_flags of the shared memory segment 300 being suspended. The SSM_SUSP flag prevents any additional checkpointing requests from being queued following the call to shm_sdwctl( ). The co-located operating system 304 then checks to see if there are any outstanding checkpoint requests for the shared memory segment 300 being unregistered. If there are any outstanding checkpointing requests, operating system 304 blocks completion of the suspension request while the outstanding checkpointing requests are allowed to complete.

Unsuspension of Shared Memory Segments

Once registered, shared memory segments 300 may be used in a shadowed or paired mode. A previously registered and suspended shared memory segment 300 may be unsuspended to restore shadowed mode operation. To unsuspend a memory segment 300, a process 302 that is a client of the shared memory segment 300 passes two arguments to shm_sdwctl( ). The first of these arguments is the descriptor 306 associated with the shared memory segment 300 being suspended. The second argument is the predefined value SM_UNSUSP. This predefined value informs shm_sdwctl( ) that the calling process 302 is requesting unsuspension of a shared memory segment 300.

Calls to request unsuspension may only be performed for a primary shared memory segment 300. The operating system 304 that is co-located with a primary shared memory segment 300 (i.e., operating system 304 for shared memory segment 300) begins to process a unsuspension request by retrieving the shmid_ds structure associated with the shared memory segment 304 being unsuspended. The co-located operating system 304 uses the shmid_ds structure to determine that the shared memory segment 300 has been allocated and is registered. The co-located operating system 304 also determines that the permissions of the calling process are adequate to perform the requested unsuspension and that the shared memory segment has been previously suspended.

The co-located operating system 304 then remotes the SSM_SUSP flag from the ssm flags of the shared memory segment 300 being unsuspended.

Checkpointing of Shared Memory Segments

Once registered, shared memory segments 300 may be used in a shadowed or paired mode. Shadow mode operation allows data to be checkpointed from a primary shared memory segment 300 to a secondary shared memory segment 300. To checkpoint a memory segment 300, a calling process 302 passes four arguments to shm_sdwchkpt( ). The first of these arguments is the descriptor 306 associated with the shared memory segment 300 being checkpointed. The second argument is a starting address within the shared memory segment 300 being checkpointed. The third address is an integer size. Together, the second and third arguments allow the calling process 302 to define the portion of a shared memory segment 300 that will be checkpointed. The final argument to shm_sdwchkpt( ) is an integer flag value. Permissible values that may be included in the flag value are SSM_SYNC or SSM_ASYNC. SSM_SYNC indicates that the shm_sdwchkpt( ) will complete synchronously. SSM_ASYNC indicates that the shm_sdwchkpt( ) will complete asynchronously.

Shm_sdwchkpt( ) can be called within the node that includes a primary memory segment 300 only if the shared memory segment 300 was registered using the SSM_PUSH flag (see description of shm_sdwctl( )). Shm_sdwchkpt( ) can be called within the node that includes a secondary memory segment 300 only if the corresponding primary memory segment 300 was registered using the SSM_PULL flag (see description of shm_sdwctl( )).

Checkpointing of Shared Memory Segments (Synchronous Operation)

When synchronous operation is requested, the operating system 304 that is co-located with the calling process 302 begins to process a checkpointing request by retrieving the shmid_ds structure associated with the shared memory segment 304 being checkpointed. The co-located operating system 304 uses the shmid_ds structure to determine that the requested checkpointing operation is valid. To be valid, the shared memory segment 300 must be allocated and registered. The permissions of the calling process must also be adequate to perform the requested checkpointing operation. Validity also requires that the SSM_SUSP, SSM_ERRSUSP or SSM_REG_PEND flags are not set for the shared memory segment. The address and size of the requested operation must also be within the limits of the shared memory segment 300.

In cases where a valid checkpointing request has been received, operating system 304 uses the appropriate network commands to move data from the primary shared memory segment 300 to the secondary shared memory segment 300. Operating system 304 pushes the data if shm_sdwchkpt( ) has been called within the node 102 that includes the primary memory segment 300 (assuming that the shared memory segment 300 was registered using the SSM_PUSH flag). Operating system 304 pulls the data if shm_sdwchkpt( ) has been called within the node 102 that includes the seondary memory segment 300 (assuming that the shared memory segment 300 was registered using the SSM_PULL flag). In general, it should be appreciated that the networking commands and protocols used to push or pull data are depending on the specific networking environment. For the described embodiment, operating system 304 performs the required push or pull using the pdev pointer for the remote node (retrieved from the ssm_rem_pdev element of the ssm_ds data structure associated with the shared memory segment 300) and an initialized ioreq structure. The ioreq structure is initialized using the arguments to shm_sdwchkpt( ) that describe the size and address of the region to be checkpointed. The ioreq structure is further initialized to include the snet IO address included in the ssm_ds data structure. Operating system 304 uses the ioreq structure to call iowrite for push checkpoint operations and ioread for pull checkpoint operations. Operating system 304 then returns zero to the calling process 302 if the iowrite or ioread call succeeds and a negative number otherwise.

Checkpointing of Shared Memory Segments (Asynchronous Operation)

When asynchronous operation is requested, the operating system 304 that is co-located with the calling process 302 begins to process a checkpointing request by retrieving the shmid_ds structure associated with the shared memory segment 304 being checkpointed. The co-located operating system 304 uses the shmid_ds structure to determine that the requested checkpointing operation is valid. To be valid, the shared memory segment 300 must be allocated and registered. The permissions of the calling process must also be adequate to perform the requested checkpointing operation. Validity also requires that the SSM_SUSP, SSM_ERRSUSP or SSM_REG_PEND flags are not set for the shared memory segment. The address and size of the requested operation must also be within the limits of the shared memory segment 300.

If the requested checkpointing operation is valid, the operating system 304 that is co-located with the primary memory segment 304 queues the requested checkpointing operation. To queue the requested operation, the co-located operating system 304 finds an unused ssm_stat data structure within the array of ssm_stat data structures that is associated with the primary shared memory segment 304. Unused ssm_stat data structures have their ssms_state elements set to CMPLT. Operating system 304 preferably, but not necessarily, searches for unused ssm_stat data structures using a hashing strategy. For this strategy, operating system 304 first forms an initial index. The initial index is equal to the ssm_chkpt_id (from the ssm_ds structure associated with the primary memory segment 300) modulo the number of entries in the array of ssm_stat data structures. Operating system 304 then begins a linear search of the array of ssm_stat data structures, starting at the entry located at the initial index.

If the linear search fails to locate an unused ssm_stat data structure, shm_sdwchkpt( ) returns a negative integer an error code. Otherwise, operating system 304 initializes the unused ssm_stat data structure to reflect the requested checkpointing operation. For this initialization, operating system 304 sets the ssms_state element of the ssm_stat data structure to PENDING. Operating system 304 also sets the ssms_id element to be equal to the ssm_chkpt_id (from the ssm_ds structure associated with the primary memory segment 300) and the ssms_qtime element to be equal to the current time. Operating system 304 then increments the ssm_chkpt_id and ssm_out_req elements of the ssm_ds structure associated with the primary memory segment 300.

Once the requested checkpointed has been queued, shm_sdwchkpt( ) returns to the calling process 302. The value returned by shm_sdwchkpt( ) is the ssm_chkpt_id used to generate the initial index (i.e., the value recorded in the ssm_stat structure used to queue the checkpoint request).

After queuing the requested checkpointing operation, operating system 304 performs the requested checkpointing operation by transfering data from the primary shared memory segment 300 to the secondary shared memory segment 300. Operating system 304 uses ioread for pull transfers and iowrite for push transfers. Operating system 304 performs this operation asynchronously, meaning that an indeterminate amount of time passes between queuing and the actual data transfer.

After the data has been transferred, operating system 304 updates the ssm_stat entry for the requested checkpointing operation. During this update, the ssms_etime is set to the elapsed time of the checkpointing operation (the current time minus the time stored in ssms_qtime). The ssms_state is set to CMPLT if no errors occurred or ERROR otherwise. The ERROR value prevents the ssm_stat entry from being reused for subsequent checkpointing operations until it is manually released. As part of error processing, operating system 304 increments the ssm_errcnt value in the ssm_ds structure and loads the returned error status into the the ssms_err element of the ssm_stat data structure. The ssm_flags element within the ssm_ds structure is set to include the values SSM_ENERR and SSM_ERRSUSP.

Asynchronous checkpointing means that the calling process 302 may not know when a requested checkpoint operation has completed. For this reason, operating system 304 is preferably, but not necessarily, configured to allow calling process 302 to specify a callback routine for a shared memory segment 300. Operating system 304 invokes the callback routine each time a checkpointing operation for the shared memory segment completes.

Status Checking Operations

Calling processes 302 use shm_sdwsat( ) to check on the status of requested checkpointing operations. Using shm_sdwstat( ), processes 302 may determine the overall status of a particular shared memory segment 300. Processes 302 may also use shm_sdwstat( ) to determine the status of an individual checkpointing request. Processes 302 may also use shm_sdwstat( ) to determine the status of the last checkpointing resulted in error To perform a status check, a process 302 that is a client of a shared memory segment 300 passes four arguments to shm_sdwsat( ). The first of these arguments is the descriptor 306 associated with the shared memory segment 300 for which the status check is being performed. The second argument is one of the predefined values SSM_STATALL, SSM_STATID or SSM_STATERR. The value selected controls whether the status check is performed for a shared memory segment 300, a checkpoint request or the last failed checkpoint request, respectively.

The third argument is a checkpoint id as returned by shm_sdwchkpt( ). The third argument identifies a particular checkpointing operation and is only used when the second argument to shm_sdwsat( ) is SSM_STATID. The final argument to shm_sdwstat( ) is a pointer. This argument points to a ssm_ds structure when shm_sdwstat( ) has is called to check on the status of a shared memory segment 300 (SSM_STATALL). Otherwise, the final argument points to a ssm_stat structure.

Shm_sdwstat( ) can be called within the node that includes a primary memory segment 300 only if the shared memory segment 300 was registered using the SSM_PUSH flag (see description of shm_sdwctl( )). Shm_sdwstat( ) can be called within the node that includes a secondary memory segment 300 only if the corresponding primary memory segment 300 was registered using the SSM_PULL flag (see description of shm_sdwctl( )).

Status Checking of Shared Memory Segments

Processes 302 call shm_sdwstat( ) specifying SSM_STATALL to check on the status of a shared memory segment 300. The operating system 304 that is co-located with the calling process 302 responds to the shm_sdwstat( ) call by retrieving the shmid_ds structure identified by the first argument to shm_sdwstat( ). Operating system 304 then uses the shmid_ds structure to retrieve the associated ssm_ds structure. Operating system 304 then copies the ssm_ds structure into the area pointed to by the fourth argument to shm_sdwstat( ). This provides the calling process with a private copy of the ssm_ds structure.

Status Checking of Checkpointing Requests

Processes 302 call shm_sdwstat( ) specifying SSM_STATID to check on the status of particular checkpoint request. The operating system 304 that is co-located with the calling process 302 responds to the shm_sdwstat( ) call by retrieving the shmid_ds structure identified by the first argument to shm_sdwstat( ). Operating system 304 then uses the shmid_ds structure to retrieve the associated ssm_ds structure. Operating system 304 then searches the ssm_stat array for an entry having an ssms_chkpt_id that matches the third argument passed to shm_sdwstat( ). If a matching entry is found, operating system 304 copies the contents of the matching entry into the ssm_stat structure passed to shm_sdwstat( ). If no matching entry is found, operating system 304 sets the ssms_state element of the ssm_stat structure passed to shm_sdwstat( ) to CMPLT_NOSTAT. In these cases, operating system 304 also zeros the remaining elements of the ssm_stat structure passed to shm_sdwstat( ). If the ssms_state element of the matching entry is set to PENDING, operating system 304 updates the ssms_etime of the ssm_stat structure passed to shm_sdwstat( ) to be the current elapsed time (i.e., the current time minus the ssms_qtime of the matching entry).

Status Checking of Failed Checkpointing Requests

Processes 302 call shm_sdwstat( ) specifying SSM_STATERR to check on the status of the last failed checkpoint request. Checking the status of the last failed request also causes that error to be purged. The operating system 304 that is co-located with the calling process 302 responds to the shm_sdwstat( ) call by retrieving the shmid ds structure identified by the first argument to shm_sdwstat( ). Operating system 304 then uses the shmid_ds structure to retrieve the associated ssm_ds structure.

Operating system 304 then examines the ssm_err_cnt element included in the retrieved ssm_ds structure. If this element is equal to zero, the shm_sdwstat( ) call returns zero to the calling process. Otherwise operating system 304 then searches the ssm_stat array for the most recent failed entry. Operating system 304 starts this search at the more recently updated entry within the ssm_stat array (i.e., the entry indexed by ssms_chkpt_id minus one). Operating system 304 then searches backwards though the ssm_stat array.

When operating system 304 locates a entry for a failed checkpoint request, operating system 304 copies the contents of the matching entry into the ssm_stat structure passed to shm_sdwstat( ). Operating system 304 also sets the ssms_state element of the matching entry to CMPLT. This allows the entry to be reused. Operating system 304 then decrements the ssm_err_cnt element included in the retrieved ssm_ds structure. The old (i.e., predecremented) value of the ssm_err_cnt element is returned to the calling process 302. Other embodiments will be apparent to those skilled in the art from consideration of the specification and practice of the invention disclosed herein. It is intended that the specification and examples be considered as exemplary only, with a true scope of the invention being indicated by the following claims and equivalents.

What is claimed is:

1. A method for providing fault tolerant operation for shared memory segments, the method comprising the steps, performed by one or more computer systems, of:
registering a first shared memory segment as a primary shared memory segment;
registering a second shared memory segment as a secondary shared memory segment;
receiving a checkpointing request from a client process of the primary shared memory segment or the secondary shared memory segment; and
transferring data from the primary shared memory segment to the secondary shared memory segment to perform the checkpointing request.

2. A method as recited in claim 1, further comprising the step of queuing the checkpointing request if the checkpointing request permits asynchronous completion.

3. A method as recited in claim 2, further comprising the step of notifying the client process when the checkpointing request actually completes.

4. A method as recited in claim 1, wherein the step of transferring data, further comprising the steps of:
pushing the data if the client process is co-located with the primary shared memory segment; and
pulling the data if the client process is not co-located with the primary shared memory segment.

5. A method as recited in claim 1, wherein the primary and secondary shared memory segments are System V or System V-like shared memory segments.
